(19) United States
(12) Patent Application Publication
(10) Pub. No.: US 2010/0302961 A1
(43) Pub. Date: Dec. 2, 2010

(54) METHOD FOR RESOLVING NETWORK CONTENTION

(75) Inventor: Michael Timmers, Leuven (BE)

Correspondence Address: KNOBBE MARTENS OLSON & BEAR LLP, 2040 MAIN STREET, FOURTEENTH FLOOR, IRVINE, CA, 92614, US

(73) Assignees: IMEC, Leuven (BE); Katholieke Universiteit Leuven, Leuven (BE)

(21) Appl. No.: 12/751,840

(22) Filed: Mar. 31, 2010

Related U.S. Application Data
(60) Provisional application No. 61/166,193, filed on Apr. 2, 2009.

(30) Foreign Application Priority Data
Apr. 1, 2009 (EP) EP 09157128.1

(51) Int. Cl. H04L 12/26; H04W 4/00

(52) U.S. Cl. 370/252; 370/328

(57) ABSTRACT

A method for resolving network contention in a wireless network having a plurality of communication devices is disclosed. In one aspect, the method includes determining a set of initial values of at least three parameters of a first device of the plurality, at least one of the at least three parameters being indicative of the transmit power of that first device. The method further includes determining, given the set of initial values, a gain measure obtainable by changing the set of initial values of the at least three parameters into a set of updated values, the gain measure taking into account the parameter indicative of the transmit power. The method further includes deciding according to the determined gain measure on using the set of updated values of the at least three parameters for the first device. Other inventive aspects relate to systems and software stored on computer readable media.

### CROSS REFERENCE TO RELATED APPLICATIONS

This application claims priority under 35 U.S.C. §119(e) to U.S. provisional patent application 61/166,193 filed on Apr. 2, 2009, which application is hereby incorporated by reference in its entirety.

### BACKGROUND OF THE INVENTION

1. Field of the Invention

The present invention generally relates to data transmission in wireless networks. More in particular, it relates to a method and device for resolving network contention in wireless networks.

2. Description of the Related Technology

As the demand for wireless connectivity grows explosively, the deployment of broadband communication systems needs to become a lot more dense. Co-existence and interoperability become key concerns. Today, the most complex wireless scene can be found in the ISM (industrial, scientific and medical) bands, where different heterogeneous networks and devices co-exist using only listen-before-talk etiquettes. In these bands the IEEE 802.11 standard is by far the most popular wireless standard for broadband access.

The success of dynamic spectrum access through simple listen-before-talk etiquettes has paved the way for opening up the spectrum. However, due to the complex nature of IEEE 802.11 networks, it is no easy task to optimize the throughput of such networks.

The IEEE 802.11 MAC protocol uses physical carrier sensing to schedule non-simultaneous transmissions. When all transmitters in a network are within each other's carrier sense range (i.e. the range within which they can detect the presence of a signal of another station) they share the channel fairly in the long run by using the IEEE 802.11 protocol. However, this assumption is clearly not always true. For multi-hop networks where nodes are distributed over an area that is larger than one carrier sense range, it has been shown that certain prominent inefficiencies arise when a terminal is not able to sense transmissions from all other terminals. This can lead to the hidden terminal problem, the exposed terminal problem, asymmetric starvation or neighborhood starvation.

The hidden terminal problem arises when a terminal able to interfere with an ongoing transmission is not silenced by this transmission. Since the terminal is not silenced, it can start transmitting and thus cause a collision at the receiver. In some cases, this problem can be handled by using the optional request-to-send/clear-to-send (RTS/CTS) handshake, defined in the 802.11 MAC protocol. However, many researchers have since noted the inefficacy of this algorithm.

The exposed terminal problem can be seen as the opposite of the hidden terminal problem. Here, a terminal is silenced, even when it forms no threat to the ongoing transmission, i.e., when a transmission from this node would not cause a collision at the receiver side. The exposed terminal problem is wasteful since it results in a suboptimal use of the spectrum over space.

Asymmetric starvation describes the following asymmetric situation that might occur when using different powers and/or carrier sense thresholds. If the signal strength detected at a transmitter terminal is below the carrier sense threshold, the terminal can attempt to proceed with the transmission. Transmitter A is listening to transmitter B and silencing its transmissions when transmitter B sends. However, transmitter B has its carrier sense threshold set so that it doesn't silence when transmitter A transmits. This can lead to unfairness or in the worst case complete starvation (when B is a hidden node for link A).

Neighborhood starvation is not so widely known. Here, a link is starved (i.e., deprived of channel access) when two or more of its neighbors, that can't hear each other, are transmitting simultaneously. Due to a loss of synchronization, those simultaneous transmissions can shift causing a partial overlap. As a result, the number of packets involved in such a collision train might be very large (because of continuous overlap) and the considered link can sense the channel busy for very long periods.

System parameters that can be tuned for maximizing the throughput of an IEEE 802.11 network comprise the transmission rate, the carrier sense threshold and the transmission power and others. Increasing the transmission rate increases the number of packets sent, but more packets will be lost at the receiver due to a lower interference tolerance. Lowering the carrier sense threshold protects a packet against interference, but decreases transmission opportunities by silencing the transmitter more often. Increasing the transmission power decreases packet losses at the receiver, but also reduces spatial reuse in the network.

A lot of work has been done on optimizing transmission rate, carrier sense threshold or transmission power individually. Patent application US2007/214247, for example, goes further, disclosing an algorithm for the joint tuning of two parameters, namely transmission rate and carrier sense threshold, in order to optimize the throughput in IEEE 802.11 networks. It introduces the concept of spatial backoff (SB). Spatial backoff assumes that the IEEE 802.11 MAC protocol has a set of discrete rates available. For each rate an associated carrier sense threshold T_{CS} is defined as follows:

$${T}_{CS} [ i ] = \frac{{T}_{Rx}}{SINR [ i ]} \qquad ( 1 )$$

where T_{Rx} is the receiver sensitivity (meaning that no packets with a receive power below T_{Rx} can be received) and SINR[i] is the signal-to-interference-noise threshold for the discrete rate R[i]. Only when the SINR at the receiver exceeds SINR[i], packets can be received. It is assumed that when using a T_{CS} equal to or lower than T_{CS}[i] to transmit at rate i, it is unlikely that the transmitter overestimate the interference tolerance at the receiver. Hence, one is looking for a T_{CS}≦T_{CS}[i].

Transmitters start at the lowest rate R[0] and its associated T_{CS}[0]. When a certain number S of consecutive transmissions succeed, the rate is increased to R[i+1], unless it is already transmitting at the highest rate. Likewise, when a certain number F of consecutive failures is seen, transmitters try to compensate by first lowering their T_{CS}. This is done as long as the T_{CS} is higher than T_{CS}[i]. When the current T_{CS} of the transmitter is equal to T_{CS}[i] and transmission continue to fail, the rate is decreased to R[i−1]. When decreasing to a lower rate, T_{CS} is reset to its last known successful value for R[i−1].

To avoid overprobing higher rates, the number of consecutive successful transmissions S[i] needed to increase the rate, increases each time the transmitter falls back to rate i. A similar procedure is used for failures.

The approach presented in US2007/214247 suffers from some important limitations. Spatial backoff (SB) only considers collisions. However, collisions are not always a good indicator for throughput as a node might increase its throughput by using a lower rate and a higher carrier sense threshold as this can significantly increase transmission opportunities. The proposed converging method can be quite slow, when the transmitter has a lot of neighbors and occasionally a packet fails through a coordinated collision. SB uses a starvation detection mechanism to avoid a complete loss of transmission opportunities. This mechanism (with no transmission during a certain period of time) is quite slow and only detects the most severe cases of starvation, where a transmitter is deprived of all access to the medium. The selection of T_{CS}[i] in SB is also quite defensive. Indeed, when the received power is high, the transmitter doesn't need to be as protective as when the received power is equal to T_{Rx}.

In the paper “A Spatial Backoff Algorithm using the joint control of carrier sense threshold and transmission rate” (X. Yang and N. Vaidya, IEEE Communications Society Conference on Sensor, Mesh and ad hoc communications and networks (SECON) 2007, pp. 501-511) authored by the inventors of US2007/214247, it is mentioned that ‘potentially all three parameters, power, CS threshold and rate, can be jointly controlled to achieve spatial backoff’ (p. 503). However, in their conclusions the authors admit themselves that ‘work is needed to determine appropriate ways to realize such a joint control’ (p. 511).

Consequently, there is a need to find a way to joint control all three parameters power, carrier sense threshold and rate.

### SUMMARY OF CERTAIN INVENTIVE ASPECTS

Certain inventive aspects relate to a method and device for resolving network contention wherein at least three parameters are jointly controlled.

One inventive aspect relates to a method for resolving network contention in a wireless network having a plurality of communication devices. The method comprises determining a set of initial values of at least three parameters of a first device of the plurality, at least one of the at least three parameters being indicative of the transmit power of the first device. The method further comprises determining, given the set of initial values, a gain measure obtainable by changing the set of initial values of the at least three parameters into a set of updated values, the gain measure taking into account that parameter indicative of the transmit power. The method further comprises deciding according to the determined gain measure on using the set of updated values of the at least three parameters for the first device.

In one embodiment the gain measure takes into account the parameter indicative of the transmit power by using a cost function wherein the transmit power is weighed. The weights may be determined such that lower transmit power values are favoured over higher transmit power values. As there is a cost involved in using a higher power, an incentive is given to the network nodes to scale down the power.

In one embodiment the at least three parameters determine a state of the first device, whereby the state is at least dependent on an indication on the receive power at a further device of the plurality with which the first device is communicating. The method then advantageously comprises conveying information on the receive power to the first device.

The at least three parameters may also comprise a transmission rate and a carrier sense threshold related to the first device.

The process of determining a gain measure is advantageously performed by means of a learning algorithm arranged for yielding an output partially determined by feedback from at least one earlier output. In other words, the output is dependent on the impact of at least one earlier output.

The gain measure is performed by means of a heuristic technique. In this case a process may be performed of determining operational communication conditions prior to applying the heuristic technique. The heuristic approach is then selected according to the determined operational communication conditions.

The determined operational conditions correspond to a scenario selected from the group of hidden terminal starvation, asymmetric starvation, and neighborhood starvation.

### BRIEF DESCRIPTION OF THE DRAWINGS

FIG. 1 illustrates the solution proposed in one embodiment.

FIG. 2 illustrates the effect of the path loss in the selection of the carrier sense threshold.

FIG. 3 illustrates possible actions for each state defined by rate and carrier sense threshold.

FIG. 4 illustrates different types of starvation mechanisms.

FIG. 5 illustrates an example to show the benefits of each contribution.

FIG. 6 illustrates a centralized topology.

FIG. 7 plots spatial backoff and spatial learning results.

FIG. 8 illustrates the impact of the heuristics on convergence speed.

FIG. 9 illustrates the performance of 802.11 terminals enhanced with spatial learning.

### DETAILED DESCRIPTION OF CERTAIN ILLUSTRATIVE EMBODIMENTS

It is widely recognized that tuning different parameters of the protocol can maximize the throughput of IEEE 802.11 networks. The network nodes are assumed to be selfish and try to maximize their own throughput. This is a commonly accepted premise in the field of game theory and cognitive radios. In certain embodiments, to find an optimal configuration of power, rate and carrier sense threshold, a learning based approach is proposed rather than totally relying on a heuristic. One proposed learning scheme is Q-learning, which is here used to exemplify the invention and described more in detail below. However, also other algorithms for reinforcement learning can be envisaged, e.g. regret matching.

Differentiation is made between the starvation types and allows the algorithm to change its response depending on the encountered situation. This is done by using heuristics to alter the exploration distribution of the Q-learning algorithm. In this way the convergence of the proposed algorithm is speeded up. In one embodiment, the algorithm exhibits the following desired properties for an 802.11 control algorithm. It is a single-channel solution and maintains interoperability with other standards. Furthermore it is backward compatible with all IEEE 802.11 protocols as long as a terminal has a tuneable power, rate and carrier sense threshold selection.

First the general framework of the control algorithm according to one embodiment is introduced (see FIG. 1). The learner interprets how the environment reacts to the selected actions and adapts his actions based on this feedback. As shown in FIG. 1, the learner may be assisted by heuristics to speed up convergence. The heuristic action suggestions are based on scenario identification, taken from local observations of the environment.

The set of possible state parameter configurations for the control algorithm is selected at design time by the operator. The state space is restricted to allow faster convergence of the algorithm. Increasing the number of possible configurations decreases convergence speed, but possibly allows more optimal results.

Due to the underlying modulation schemes, the rate is the least flexible parameter and hence does not need any design-time restriction. All rates that the platform supports are used to bound the more flexible parameters, namely carrier sense thresholds and power.

Regarding the transmission power the following rule-of-thumb is used: the number of transmission powers is selected equal to the number of available rates and they are distributed these uniformly over the interval [max(Pt)/ηR, max(Pt)], where ηR is the number of available rates and max(Pt) the maximum available transmission power.

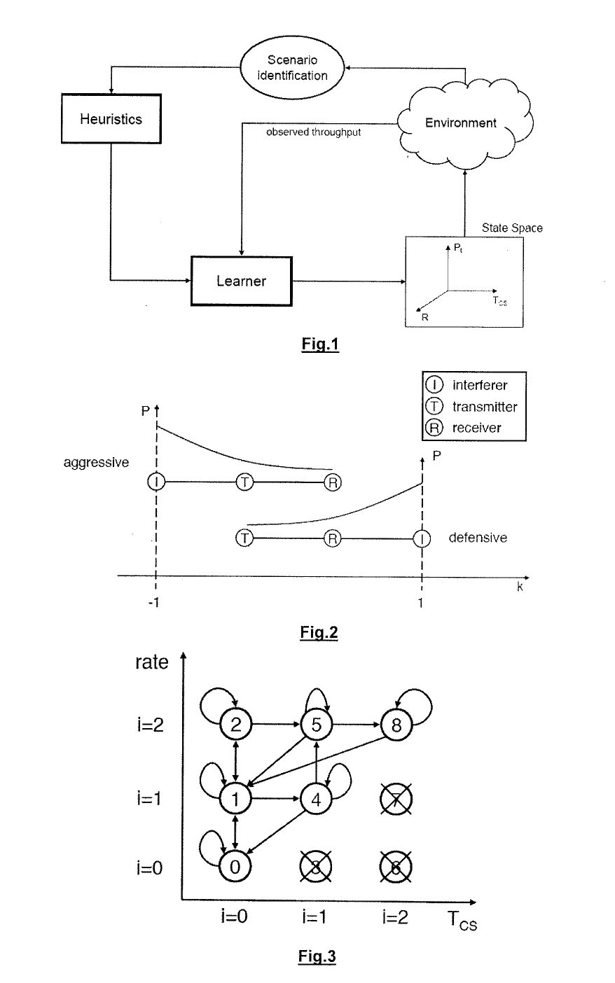

The selection of TCS[i], which is the most flexible parameter, is performed as follows. Rather than relying on the same states for each transmitter, the transmitter is allowed to select its TCS[i] based on the path loss:

$${T}_{CS} [ i ] = {( \frac{{P}_{r}}{{P}_{t}} )}^{k} ( \frac{{P}_{r}}{SINR [ i ]} - {σ}_{0}^{2} ) \qquad ( 2 )$$

where Pₜ is the transmit power, Pᵣ is the received power and σ₀² a model for the noise power at the receiver. The operator can choose the parameter k from the interval [−1, 1]. The aggressive point, k=−1, assumes that the interference power suffers from the same path loss as the link between transmitter and receiver. The defensive point, k=1, assumes that the interference power suffers an extra path loss from receiver to transmitter (see FIG. 2). Throughout the remainder of this description, a neutral setting (k=0) is used.

Of course, the transmitter needs to know the value of Pᵣ. A commonly accepted way is to piggyback the received power in the acknowledgment. Even when it would be difficult to estimate the received power, the spatial learning algorithm in one embodiment is capable of compensating by selection of appropriate states within the space. This improved state space is denoted Pᵣ-states.

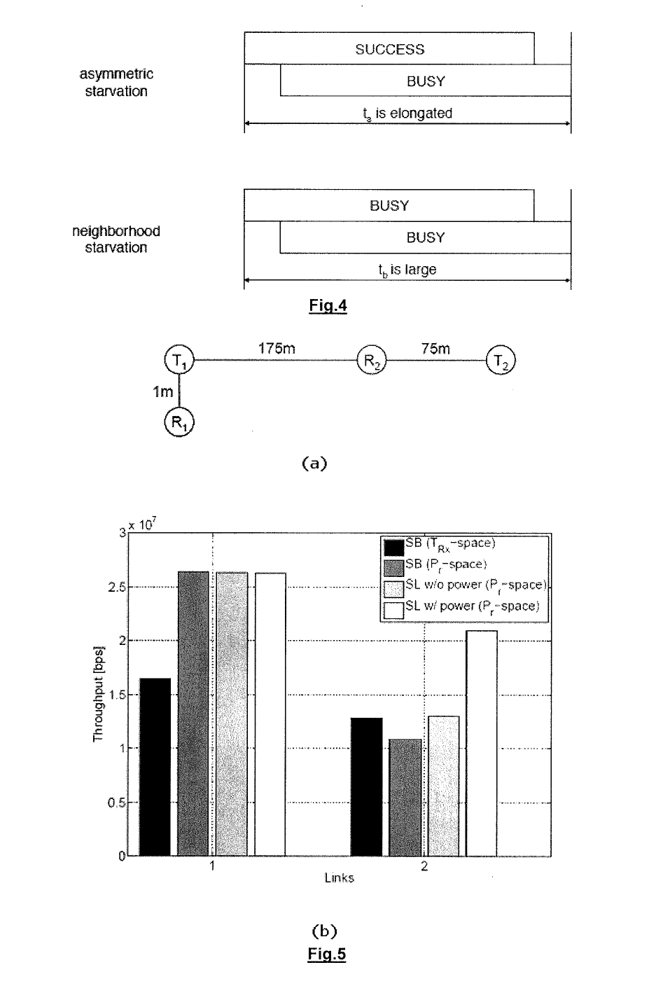

To find the optimal configuration in the state space, a learning based approach is proposed rather than totally relying on a heuristic. A suitable learning scheme is Q-learning, which does not need a model of the environment and can be used online. The Q-learning algorithm works by estimating the values of state-action pairs. In the context of one embodiment, an action is the transition from the current state (s_{c}) to a new state (sₙ). The value Q(s_{c}, sₙ) is defined as the expected discounted sum of future payoffs obtained by going to the new state and following an optimal policy thereafter. Once these values have been learned, the optimal action from any state is the one with the highest Q-value. The standard procedure for Q-learning is as follows. All Q-values are initialized to 0. During the exploration of the state space, the Q-values are updated as follows:

$$Q ( {s}_{c} , {s}_{n} ) ← ( 1 - α ) Q ( {s}_{c} , {s}_{n} ) + α [ ( 1 - γ ) r + γ {max}_{s ∈ A ( {s}_{n} )} Q ( {s}_{c} , {s}_{n} ) ] \qquad ( 3 )$$

where α is a forget factor, γ a learning parameter and A denotes the set of candidate new states. To implement Q-learning the actions within the state space need to be defined first. The possible actions in each state can be seen in FIG. 3 for an example with three rates available. In each state the transmitter can decide (if possible) to remain in that state (i.e. to keep the current configuration), to increase the rate, decrease the carrier sense threshold T_{CS} or decrease the rate. When decreasing the rate, the transmitter is forced to reset its T_{CS} to T_{CS}[0]. The states where T_{CS} is smaller than T_{CS} [i] have been pruned as explained later on. The reward r is defined as the throughput increase for going to state sₙ:

r=S(sₙ)−S(s_{c}) (4)

where S(s) is the throughput seen in state s.

It is important to note that the Q-learning algorithm updates the estimate for each action, but in fact does not specify what actions should be taken. It allows arbitrary experimentation while at the same time preserving the current best estimate of the states' values. For example, an instantiation of simulated annealing as follows can be used. The terminals explore using a soft-max policy, where each terminal selects an action with a probability given by the Boltzmann distribution (more details on this are provided in the paper “Exploring versus Exploiting: Enhanced Distributed Cognitive Coexistence between IEEE 802.11 and IEEE 802.15.4”, M. Timmers et al., Proc. of the IEEE Conference on Sensors, October 2008, which is incorporated herein by reference)

$${p}_{Q} ( {s}_{c} , {s}_{n} ) = \frac{{e}^{\frac{Q ( {s}_{c} , {s}_{n} )}{T}}}{{\sum }_{∀ s ∈ A ( {s}_{c} )} {e}^{\frac{Q ( {s}_{c} , s )}{T}}} \qquad ( 5 )$$

where T is the temperature that controls the amount of exploration. For higher values of T the actions are equiprobable. By annealing the algorithm (cooling it down) the policy becomes more and more greedy. The following annealing scheme is used, whereby 0 denotes the annealing factor:

Tₖ₊₁←θTₖ (6)

To further improve network-wide throughput and fairness, transmitters are allowed to tune their power. Of course, from a throughput point of view, the optimal decision is always to send at the maximum power. So terminals need to be given (a small) incentive to scale down the power. Hence a cost is introduced for using higher powers:

r(sₙ,s_{c})= ρ̅(lₙ)S*(sₙ)− ρ̅(l_{c})S*(s_{c}) (7)

where l is the power index (l=0 refers to the lowest power, l=nₚ−1 refers to the highest power). The reward factors are defined as follows:

ρ̅(l)= ρ̅^{l}:lΣ[0,nₚ−1] (8)

where ρ is an element of (0, 1] and nₚ is the number of available transmission powers. With a high ρᵢ nodes scale down their power, until they see a drop in throughput. With a lower ρᵢ they even accept a small reduction in throughput. By allowing good links to scale down their power without dropping their throughput, interference levels drop for the surrounding links. These links might now be able to send at a higher rate. This again improves network-wide throughput and fairness.

Reward and actions having been defined, we now detail the implementation in the IEEE 802.11 MAC protocol. The basic concept is to stay in one state for a certain time tᵤ. After this time has passed, the Q-values are updated and a new state is selected according to expression (5). As one wants to track the throughput as reward, a logical choice would be to count the number of successfully transmitted packets during tᵤ. However, this number of packets is highly dependent of the instantiations of the backoff values during the observation time. This noise might cause the learner to misinterpret the reward. To remove the correlation between backoff selection and observed throughput, a theoretical saturation throughput S* of IEEE 802.11 is used rather than the observed throughput. Here, the throughput is calculated based on five parameters: the collision probability p_{c}, the busy probability p_{b}, the length of a collision slot t_{c}, the length of a busy slot t_{b} and the length of a successful slot tₛ. By using the transmissions as a probing for p_{c}, tₛ and t_{c} and observing p_{b} and t_{b} when the transmitter is not sending, a theoretical throughput can be calculated, which is no longer dependent on the actual instantiations of the backoff value. However, not all unwanted correlations are removed. Indeed, the throughput is also dependent on the backoff values and actions of other transmitters in the neighborhood. As the transmitter has no way of knowing these, one tries to average out these variations by observing the following relations:

p_{c}=f(R,Pₜ,T_{CS}),t_{c}=f(R,Pₜ,T_{CS}),tₛ=f(R,Pₜ,T_{CS})

pᵢ=f(Pₜ,T_{CS}),t_{b}=f(Pₜ,T_{CS})

One can see that pᵢ and t_{b} are only a function of T_{CS} and not rate dependent. Hence, the throughput estimation of a certain state can be updated based on observations in states that have the same T_{CS}.

Because the addition of power brings extra states, convergence is slower. Generally, Q-learning is a slow and blind method, but reaches an optimal setting. On the other side, heuristics are fast, but might lead to a suboptimal setting. By allowing heuristics to alter the distribution during the exploration phase of the Q-learning, one can combine the best of both worlds. In order to use heuristics, it must first be known which are the present operational conditions wherein the communication takes place, i.e. which is the present scenario. Scenarios that one tries to distinguish, may be hidden terminal starvation, asymmetric starvation and neighborhood starvation.
Hidden terminal starvation is the easiest to detect, as only an inspection of p_{c} is needed. Indeed, it is signaled through a high collision probability.
Asymmetric starvation is detected as follows. A timer is kept from the beginning of transmission until the backoff timer can be decremented. If a successful transmission lasts longer than expected (the expected duration of a collision or a successful transmission can be easily calculated), a neighboring node started transmitting during our transmission. This means that this node was not listening to our transmission, but we are listening to his transmission. Hence, this is a clear case of asymmetric starvation (see FIG. 4).
Neighborhood starvation is detected by long busy times (see FIG. 4). Using this detection mechanism, one cannot distinguish between slow neighbors and neighborhood starvation. However, as the recommendation for this situation is the same (you want to increase T_{CS}), this does not really matter.

For each (combination of) scenario(s), heuristic probabilities need to be defined. These are based on the recommendations, found in Table I. For instance, when a node is dealing with asymmetric starvation, it makes sense to either increase the power or decrease the carrier sense threshold in order to alleviate this situation.

TABLE 1

| Starvation Mechanism | Recommend | Neutral | Avoid |
|---|---|---|---|
| No Starvation | increase rate | stay | decrease T_{CS} |
| | decrease power | | |
| Hidden Node | increase power | | increase rate |
| Starvation | decrease T_{CS} | | stay |
| Asymmetric | increase power | | stay |
| Starvation | decrease T_{CS} | | |
| Neighborhood Starvation | increase T_{CS} | | stay |

The heuristic probabilities need to be added in the Q-learning mechanism. The idea is that the heuristic probabilities are followed during the exploration phase and that when the temperature cools down, the Q-learning takes over from the heuristic. This can be achieved by redefining (5) as follows:

$${p}_{HQ} ( {s}_{c} , {s}_{n} ) = \frac{{p}_{H} ( {s}_{c} , {s}_{n} ) {e}^{\frac{Q ( {s}_{c} , {s}_{n} )}{T}}}{{\sum }_{∀ s ∈ A ( {s}_{c} )} ( {p}_{H} ( {s}_{c} , s ) {e}^{\frac{Q ( {s}_{c} , s )}{T}} )} \qquad ( 9 )$$

Care has to be taken in choosing the heuristic probabilities. An equiprobable distribution for p_{H} turns (9) back into regular Q-learning. The heuristic limits exploration for the Q-learning by guiding the algorithm to what it feels are the correct states to turn to. This speeds up convergence, as explained above, but increases the risk of settling down in a suboptimal state as some states (among which, the optimal) might not have been visited during exploration.

The performance of the proposed algorithm has been evaluated through an extensive simulation study. Some obtained results are presented here. All simulations are done using a shadowing model with a path loss exponent of 4 and a shadowing of 4 dB. As can be seen in Table II, it is assumed terminals are capable of transmitting at four discrete rates. Also four power levels are used. For parameters not present in Table II the default values are used.

TABLE 2

| (Rate [Mbps], SINR [dB]) | Power [mW] |
|---|---|
| (9, 7.78) | 250 |
| (18, 10.79) | 125 |
| (36, 18.80) | 66.25 |
| (54, 24.56) | 33.125 |

As a first result, an illustrative example is presented that demonstrates the benefits of the different contributions. The scenario is presented in FIG. 5(a). In FIG. 5(b), one can see that the T_{CS} based on T is too defensive. Link 1 can increase its throughput with a smarter state space selection. This, however, has an impact on the throughput for link 2. When using SL without power flexibility, one can quickly converge on the correct state, which is the second-lowest rate. When link 1 is allowed to decrease its power, interference for link 2 reduces and it is able to sustain a higher rate.

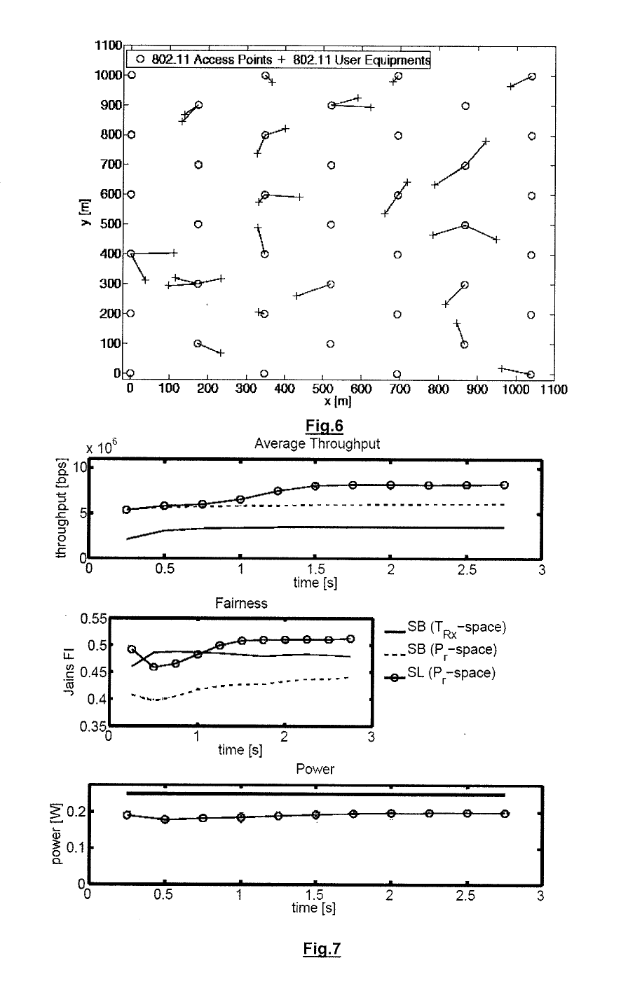

As illustrated in FIG. 6, it is assumed that 802.11 access points form a hexagonal grid. The user equipments (UEs) are distributed according to a spatial Poisson point process with a density δ=25 nodes/km². UEs are sending uplink traffic using the DCF mode. The results for a complete ad-hoc network are similar, but this topology is believed to be a better representation of 802.11 networks today.

In FIG. 7 a comparison is presented between SB and SL. Results are averaged over 100 seeds, using the topology of FIG. 6. One can see that the new T_{CS} definition according to one embodiment, based on Pᵣ significantly increases throughput. The definition based on T_{Rx} does not provide a lot of differentiation among the different states. This can be seen by the fact that SL cannot improve over SB using these states and by the fact that it reduces the transmission power significantly for these states. However the introduction of the new states also causes more unfairness in the network. By allowing the nodes to scale down power, SL compensates for this and reaches the same levels of fairness as the T_{Rx}-states. Most importantly, SL is shown to outperform SB by 33% in throughput using the Pᵣ based states.

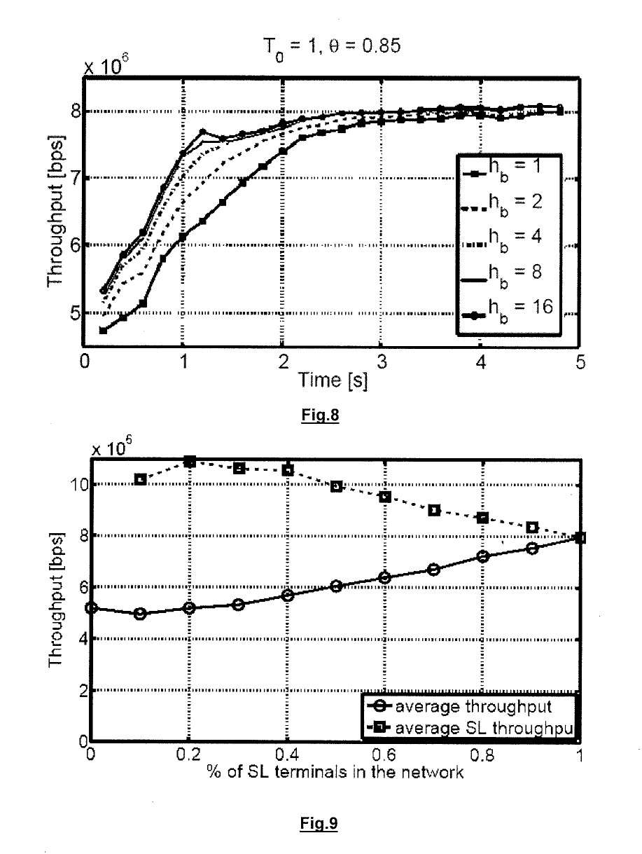

The impact of heuristics on the convergence of SL is illustrated in FIG. 8. Again, the topology of FIG. 6 is used and averaged over 100 seeds. It can be clearly seen that the use of domain knowledge in the form of heuristics results in a significant increase in convergence speed. To demonstrate the interoperability of SL, the performance of SL is shown in a legacy 802.11 network in FIG. 9. As most of the current commercial 802.11 cards support some kind of auto-rate fallback (ARF), this was implemented for the legacy 802.11 terminals. One can see that SL performs better among legacy 802.11 terminals as these cannot optimize their own transmissions fully, generating opportunities for the SL terminals. However, adding more SL terminals doesn't reduce the average throughput of the SL terminals that much. This makes for a compelling business case, where the first adopters are rewarded the most.

Another embodiment relates to a system wherein the foregoing embodiments of a method are at least partly implemented, or in other words, to a system adapted for performing the foregoing embodiments of a method. An exemplary system includes at least one programmable processor coupled to a memory subsystem that includes at least one form of memory, e.g., RAM, ROM, and so forth. A storage subsystem may be included that has at least one disk drive and/or CD-ROM drive and/or DVD drive. In some implementations, a display system, a keyboard, and a pointing device may be included as part of a user interface subsystem to provide for a user to manually input information. Ports for inputting and outputting data also may be included. More elements such as network connections, interfaces to various devices, and so forth, may be included. The various elements of the system may be coupled in various ways, including via a bus subsystem for simplicity as a single bus, but will be understood to those in the art to include a system of at least one bus. The memory of the memory subsystem may at some time hold part or all of a set of instructions that when executed on the system implement the step(s) of the method embodiments described herein.

It is to be noted that the processor or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. Furthermore, aspects of the invention can be implemented in a computer program product stored in a computer-readable medium for execution by a programmable processor. Method steps of aspects of the invention may be performed by a programmable processor executing instructions to perform functions of those aspects of the invention, e.g., by operating on input data and generating output data. Accordingly, the embodiment includes a computer program product which provides the functionality of any of the methods described above when executed on a computing device. Further, the embodiment includes a data carrier such as for example a CD-ROM or a diskette which stores the computer product in a machine-readable form and which executes at least one of the methods described above when executed on a computing device.

Although the present invention has been illustrated by reference to specific embodiments, it will be apparent to those skilled in the art that the invention is not limited to the details of the foregoing illustrative embodiments, and that the present invention may be embodied with various changes and modifications without departing from the spirit and scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the spirit and scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

What is claimed is:

1. A method of resolving network contention in a wireless network having a plurality of communication devices, the method comprising:
determining a set of initial values of at least three parameters of a first device of the plurality of devices, at least one of the at least three parameters being indicative of a transmit power of the first device;
determining, based at least in part on the set of initial values, a gain measure obtainable by changing the set of initial values into a set of updated values, the gain measure be determined taking into account the parameter indicative of the transmit power; and
deciding according to the determined gain measure on using the set of updated values of the at least three parameters for the first device.

2. The method of claim 1, wherein the gain measure takes into account the parameter indicative of the transmit power by using a cost function wherein the transmit power is weighed.

3. The method of claim 2, wherein weights are determined such that lower transmit power values are preferred over higher transmit power values.

4. The method of claim 1, wherein the at least three parameters determine a state of the first device, the state being at least dependent on an indication on the receive power at a second device of the plurality of devices with which the first device is communicating.

5. The method of claim 4, further comprising conveying information on the receive power to the first device.

6. The method of claim 1, wherein the at least three parameters also comprise a transmission rate and a carrier sense threshold related to the first device.

7. The method of claim 1, wherein determining a gain measure is performed by a learning algorithm arranged for yielding an output partially determined by feedback from at least one earlier output.

8. The method of claim 1, wherein the gain measure is determined by a heuristic technique.

9. The method of claim 8, wherein, operational communication conditions are determined prior to applying the heuristic technique, wherein the heuristic technique is selected according to the determined operational communication conditions.

10. The method of claim 9, wherein the determined operational conditions correspond to a scenario selected from a group of hidden terminal starvation, asymmetric starvation, and neighborhood starvation.

11. The method of claim 1, wherein the method is performed by one or more computing devices.

12. A computer-readable medium having stored thereon a program which, when executed on a processor, performs the method of claim 1.

13. A system for resolving network contention in a wireless network having a plurality of communication devices, the system comprising:
first means for determining a set of initial values of at least three parameters of a first device of the plurality of devices, at least one of the at least three parameters being indicative of a transmit power of the first device;
second means for determining, based at least in part on the set of initial values, a gain measure obtainable by changing the set of initial values into a set of updated values, the gain measure be determined taking into account the parameter indicative of the transmit power; and
means for deciding according to the determined gain measure on using the set of updated values of the at least three parameters for the first device.

14. The system of claim 13, wherein at least one of the first determining means, the second determining means, and the deciding means comprises at least one computing device.

15. A system for resolving network contention in a wireless network having a plurality of communication devices, the system comprising:
an first determining module configured to determine a set of initial values of at least three parameters of a first device of the plurality of devices, at least one of the at least three parameters being indicative of a transmit power of the first device;
a second determining module configured to determine, based at least in part on the set of initial values, a gain measure obtainable by changing the set of initial values into a set of updated values, the gain measure be determined taking into account the parameter indicative of the transmit power; and
a decision module configured to decide according to the determined gain measure on using the set of updated values of the at least three parameters for the first device.

16. The system of claim 15, further comprising at least one computing device configured to execute at least one of the first determining module, the second determining module, and the decision module.

17. The system of claim 15, wherein the gain measure takes into account the parameter indicative of the transmit power by using a cost function wherein the transmit power is weighed.

18. The system of claim 15, wherein the at least three parameters determine a state of the first device, the state being at least dependent on an indication on the receive power at a second device of the plurality of devices with which the first device is communicating.

19. The system of claim 15, wherein the gain measure is determined by a learning algorithm arranged for yielding an output partially determined by feedback from at least one earlier output.

20. The system of claim 15, wherein the gain measure is determined by a heuristic technique.
